(19) United States
(12) Patent Application Publication
(10) Pub. No.: US 2004/0192528 A1
(43) Pub. Date: Sep. 30, 2004

(54) Ceramic roller

(76) Inventors: Munehiko Fukase, Hamamatsu-shi (JP); Toshiyuki Kishida, Hamamatsu-shi (JP); Isami Abe, Hamamatsu-shi (JP); Takahiro Ohmura, Hamamatsu-shi (JP)

Correspondence Address: LINIAK, BERENATO & WHITE, LLC, 6550 ROCK SPRING DRIVE, SUITE 240, BETHESDA, MD, 20817, US

(21) Appl. No.: 10/810,612

(22) Filed: Mar. 29, 2004

(30) Foreign Application Priority Data
Mar. 31, 2003 (JP) 2003-097111
Mar. 31, 2003 (JP) 2003-097117
Mar. 31, 2003 (JP) 2003-097120

(51) Int. Cl. G03G 15/00; B25F 5/02

(52) U.S. Cl. 492/53

(57) ABSTRACT

It is an object of the present invention to provide a ceramic roller which is used as a guide roller with a superior heat-insulating property to, for example, a high temperature pressing belt.

A ceramic roller is provided which comprises a shaft, a cylindrical layer, and a surface coating layer arranged in that order from the central side thereof, at least a part of the cylindrical layer being made of a ceramic with a low bulk density of 0.2 to 1.5 g/cm³, the ceramic being formed from 100 parts by weight of an inorganic binder and 0 to 500 parts by weight of a heat-resistant inorganic material.

### BACKGROUND OF THE INVENTION

1. Field of the Invention

The present invention relates to a ceramic roller which is useful as a guide roller for guiding a nip belt or fixing belt or as a conveying roller, an auxiliary roller, a drive roller, a release roller, a tension roller, a driving roller or the like in a heat fixing device of a copying machine, an image-forming apparatus, or the like, and more particularly to a ceramic roller of which the heat conducting property is reduced so that the heat-loss of a piece guided by the ceramic roller is suppressed, thus serving as a heat energy-saving device.

2. Description of the Related Art

Referring to image-forming apparatuses such as electronic copying machines, laser printers, facsimiles, or the like, an optical image is projected onto the surface of a photosensitive piece uniformly charged in the dark, so that an electrostatic latent image is formed on the surface of the photosensitive piece corresponding to the optical image. Thereafter, charged fine particles (toner) as a developer are sprayed on the surface of the latent image and adhere to the surface by electrostatic force. Thus, the image is developed. The surface of printing paper charged to have a polarity opposite to that of the fine particles is caused to overlap the surface of the photosensitive piece, so that the fine particles are transferred onto the surface of the printing paper. The fine particles transferred onto the surface of the paper are heated under pressure by means of a fixing roller (heat roller), and thus, are melted and fixed on the printing paper. Thus, the image is reproduced.

In image-forming apparatuses such as electronic copying machines, laser printers, facsimiles, and the like, heat-fixing devices are used, in which a toner image formed and carried on an image carrier such as a paper sheet or a resin sheet is heated, and thus, is melted and fixed on the image carrier. Basically, the heat fixing devices are divided into a roller nip system and a belt nip system according to the structures thereof. According to the roller nip system, an image carrier having a toner image formed and carried thereon is supplied to a press-contact portion between a fixing roller and a pressing roller which are pressed together so as to come into contact with each other. Thus, the toner image is heated under pressure in order to fix it onto the image carrier. According to the belt nip system, an endless fixing belt rotates around at least two contact-rollers. Moreover, a pressing roller is press-contacted with a part of the fixing belt. An image carrier having a toner image formed and carried thereon is supplied to the press-contact portion between the fixing belt and the pressing roller. The toner image is fixed on the image carrier due to the heat energy of the fixing belt with a pressure being applied to the image carrier.

For example, Japanese Unexamined Patent Application Publication No. 10-312132 (Patent Document 1) (paragraph numbers 0004 to 0006, FIG. 4) describes an example of heat-fixing devices of the known belt nip system.

In particular, according to Patent Document 1, as shown in FIG. 7, which is one of the accompanying drawings of the present invention, an image carrier 5 carrying a toner image 6 delivered from a transfer device (not shown) is supplied to the nip between a heating roller 1 and a belt 2 in contact with the peripheral surface of the heating roller 1. The toner image 6 is fixed on the surface of the image carrier 5 by heat and a pressure applied when the image carrier 5 is passed through the nip.

The heating roller 1 is a hollow cylindrical piece which is rotated in the arrowed direction A in FIG. 7. A heater la is disposed inside the heating roller 1 and functions as a heating source for melting a toner. The belt 2 is endless and is provided so as to rotate around an inlet-side guide roller 3 and an outlet-side guide roller 4. For example, a fluorine-containing coating layer having a superior release property is formed on a heat-resistant elastic piece, e.g., made of a silicone rubber with a thickness of about 1 mm or the like.

The inlet-side guide roller 3 and the outlet-side guide roller 4 are made of metal, are idlers, and are arranged in such a manner that the rotational axial lines of the rollers 3 and 4 are in parallel to the axial line of the heating roller 1. The belt can come into contact with the peripheral surface of the heating roller 1 in the area thereof corresponding to the central area defining an arch. According to the known example, a heater 7 for heating the belt 2 is disposed inside the inlet-side roller 3.

In the heat-fixing device of the above-described belt nip system, a roller-side temperature sensor 8 for detecting the surface temperature of the heating roller 1 and a belt-side temperature sensor 9 for detecting the temperature at the nip surface of the belt 2 are arranged to properly control the heating temperature for fixing. Moreover, the heaters 7 and la are provided as heat sources for heating the nip-surfaces of the heating roller 1 and the belt 2. Thus, when the heat-fixing device is operated, the heaters and the temperature sensors operate so that the temperatures on the nip surfaces of the heating roller 1 and the belt 2 are controlled at predetermined values.

However, conventionally, both the inlet-side guide roller 3 and the outlet-side guide roller 4, which support the endless belt 2, are made of metal in the heat fixing device of the belt nip system. Thus, the guide rollers and so forth have a high thermal conductivity, and hence, the heat radiation from the rollers is high.

Accordingly, when it is desired for the heating temperatures of the guide rollers to be maintained, e.g., at 200° C., the radiation heat levels of the heated metallic guide rollers are very large in an ordinary temperature environment. Thus, the loss of heat energy is large, and the economics with respect to the heat are inferior. Thus, the energy-saving effect is low.

If the heating temperature of the belt 2 which presses and heats the image carrier 5 in cooperation with the heating roller 1 is lower than the set temperature, the toner on the image carrier 5 is insufficiently fixed. Thus, a high quality image can not be reproduced by fixing. Accordingly, it is necessary to constantly pre-heat the heating roller and the belt guide rollers to a predetermined temperature. Thus, the pre-heating (warming up) cannot be omitted.

The quantity of heat required for the completion of the preheating also depends on the heat loss (radiation heat) of the metallic guide rollers, which are components of the heat fixing device. Nowadays, heat energy saving (electric power saving) has been in more demand. Thus, it is necessary for the guide rollers to have a superior heat-insulating property, i.e., a small heat loss.

### SUMMARY OF THE INVENTION

In view of the foregoing, the present invention has been devised. It is an object of the present invention to provide a ceramic roller which is used as a guide roller for guiding a pressing belt in a belt-nip system heat-fixing device in an image-forming apparatus such as an electron copying machine, a laser printer, a facsimile, and so forth, whereby the guide roller has an enhanced heat-insulating property so that the heat loss can be suppressed, and the energy-saving effect can be enhanced.

The inventors have performed intensive investigation to achieve the above-described object. As a result, the inventors have found that the loss of heat energy can be suppressed, that is, the energy-saving effect can be enhanced by a ceramic roller provided with a cylindrical layer made of a ceramic with a low bulk density (first knowledge).

Moreover, the inventors have found that the loss of heat energy can be suppressed, that is, the energy-saving effect can be enhanced by formation of grooves or convexities and concavities on the peripheral surface of the cylindrical layer (second knowledge).

Moreover, the inventors have found that the loss of heat energy can be suppressed, that is, the energy-saving effect can be enhanced by formation of the cylindrical layer in a cylindrical shape having a hollow shaft-hole (third knowledge).

According to a first aspect of the present invention devised based on the first knowledge, a ceramic roller is provided which comprises a shaft, a cylindrical layer, and a surface coating layer arranged in that order from the central side thereof, at least a part of the cylindrical layer being made of a ceramic with a low bulk density of 0.2 to 1.5 g/cm³, the ceramic being formed from 100 parts by weight of an inorganic binder and 0 to 500 parts by weight of a heat-resistant inorganic material.

The loss of heat energy emitted from the ceramic roller is small. Thus, the energy-saving effect is high.

As described above, the surface coating layer is provided on the surface of the cylindrical layer. Thus, even if a porous ceramic that is readily damaged is used as the ceramic with a low bulk density for the cylindrical layer, damage to or cracks in the porous ceramic can be prevented. Thus, the ceramic roller has a long service life.

Moreover, as described above, the ceramic roller is provided with the cylindrical layer formed from the ceramic with a low bulk density. Thus, the heat conductivity for a piece to be guided is small, and the thermal-insulating effect is high.

Preferably, the cylindrical layer is formed of a ceramic with a low bulk density having a heat capacity per unit volume of 1×10⁻⁴ to 1.5×10⁻³ KJ/(K·cm³).

Preferably, the thermal conductivity of the cylindrical layer is in the range of 0.03 to 1.0 W/(m·K).

Grooves or convexities and concavities may be formed on the peripheral surface of the cylindrical layer.

Accordingly, the contact area between the ceramic roller and a piece to be guided can be reduced. Thus, the thermal conduction between the piece to be guided and the cylindrical layer can be suppressed. As a result, the quantity of heat absorbed by the piece to be guided can be suppressed.

The cylindrical layer may be provided with a hollow shaft hole into which the shafts are disposed. The top-end of each shaft protrudes externally from the cylindrical layer, and the other end is fixed in one of both ends of the shaft hole. Thus, the part of the shaft hole existing between both the shafts constitutes a hollow portion.

Thus, the heat capacity of the ceramic roller is significantly reduced. This contributes to heat energy-saving.

The surface coating layer may be made of a fluororesin. Preferably, the fluororesin is a tube of PFA resin.

Accordingly, the surface coating layer can be relatively easily formed by introducing a ceramic for forming the cylindrical layer into a tube when the roller is produced, and heating the ceramic. Thus, the ceramic roller can be efficiently produced.

The surface coating layer may be coated with a glass layer.

The surface coating layer has a high heat resistance and a superior surface smoothness.

Preferably, the ceramic roller is used in a fixing device. More preferably, the ceramic roller is used in a non-pressing part of the fixing device.

In this specification, the roller used in the non-pressing part of the fixing device means a roller arranged in opposition to a fixing roller, i.e., a roller other than a so-called pressing roller, such as a conveying roller, an assisting roller, a drive roller, a release roller, or the like which requires no large pressure for fixing a toner onto paper. A fixing belt with a high temperature is suppressed from being cooled with these rollers. Thus, the industrial advantages of the ceramic roller are significant.

It is not necessary for the above-described non-pressing part to have a significantly high strength. Therefore, the bulk density of the cylindrical layer can be further reduced. Thus, the ceramic roller having the advantages inherent in the ceramic with a low bulk density can be provided.

According to a second aspect of the present invention devised based on the second knowledge, a ceramic roller is provided which comprises a shaft, a cylindrical layer with a peripheral surface formed on the peripheral surface of the shaft excluding both the ends of the shaft, the peripheral surface of the cylindrical layer having grooves or concavities and convexities formed thereon, and a surface coating layer.

Accordingly, the contact area between the ceramic roller and a piece to be guided can be reduced. Thus, the thermal conduction between the piece to be guided and the cylindrical layer can be suppressed. As a result, the quantity of heat absorbed by the piece to be guided can be suppressed.

Preferably, at least a part of the cylindrical layer is made of a ceramic with a low bulk density of 0.2 to 1.5 g/cm³, the ceramic being formed from 100 parts by weight of an inorganic binder and 0 to 500 parts by weight of a heat-resistant inorganic material.

Preferably, the cylindrical layer is formed of a ceramic with a low bulk density having a heat capacity per unit volume of 1×10⁻⁴ to 1.5×10³ KJ/(K·cm³).

As described above, as the cylindrical layer, a layer of a ceramic with a low bulk density is formed. Thus, the heat conduction for a piece to be guided is reduced, and the thermal insulating effect is high.

Preferably, the thermal conductivity of the cylindrical layer is in the range of 0.03 to 1.0 W/(m·K).

According to this constitution, the thermal conduction between the ceramic roller and a piece to be guided with the roller can be further suppressed, due to the synergetic effect between the thermal conductivity of the material of the cylindrical layer and the grooves or the convexities and concavities formed on the peripheral surface of the roller. As a result, the quantity of heat absorbed by the piece to be guided can be suppressed.

As described above, the surface coating layer is provided on the surface of the cylindrical layer. Thus, even if a porous ceramic that is readily damaged is used as the ceramic with a low bulk density for the cylindrical layer, damage to cracks in the porous ceramic can be prevented. Thus, the ceramic roller has a long service life.

The cylindrical layer may be provided with a hollow shaft hole into which the shafts are disposed. The top-end of each shaft protrudes externally from the cylindrical layer, and the other end is fixed in one of both the ends of the shaft hole. Thus, the part of the shaft hole existing between both of the shafts constitutes a hollow portion.

Thus, the heat capacity of the ceramic roller can be significantly reduced due to the air existing in the hollow portion. This contributes to the heat energy-saving.

The surface coating layer may be made of a fluororesin. Preferably, the fluororesin is a tube of PFA resin. Accordingly, the surface coating layer can be relatively easily formed by introducing a ceramic for forming the cylindrical layer into a tube when the roller is produced, and heating the ceramic. Thus, the ceramic roller can be efficiently produced.

The surface coating layer may be coated with a glass layer. The surface coating layer has a high heat resistance and a superior surface smoothness.

Preferably, the ceramic roller is used in a fixing device. Especially, the ceramic roller, which is used in a non-pressing part of the fixing device, can effectively exhibit the advantages inherent in the ceramic with a low bulk density.

According to a third aspect of the present invention devised based on the third knowledge, a ceramic roller is provided which comprises a cylindrical layer formed in a cylindrical shape having a hollow shaft-hole, a pair of shafts, one of which has the top-end thereof protruding externally from the cylindrical layer and has the other end fixed in the cylindrical layer, the shaft hole forming a hollow portion between the ends of both the shafts, and a surface coating layer formed on the outer peripheral surface of the cylindrical layer.

Accordingly, the heat capacity of the ceramic roller can be significantly reduced due to the formation of the cylindrical layer having a cylindrical shape and the air existing in the hollow portion. This contributes to the heat energy saving.

Preferably, at least a part of the cylindrical layer is made of a ceramic with a low bulk density of 0.2 to 1.5 g/cm³, the ceramic being formed from 100 parts by weight of an inorganic binder and 0 to 500 parts by weight of a heat-resistant inorganic material.

Thus, the heat conduction to a guided piece is less, and the heat-insulating effect is further increased.

Preferably, the cylindrical layer is formed of a ceramic with a low bulk density having a heat capacity per unit volume of 1×10⁻⁴ to 1.5×10⁻³ KJ/(K·cm³).

Preferably, the thermal conductivity of the cylindrical layer is in the range of 0.03 to 1.0 W/(m·K).

According to this constitution, the thermal conduction between the ceramic roller and a piece guided with the roller can be further suppressed, due to the synergetic effect between the heat capacity and/or the thermal conductivity inherent in the material of the cylindrical layer and the air existing in the hollow. As a result, the quantity of heat absorbed by the guided piece can be suppressed.

As described above, the surface coating layer is provided on the surface of the cylindrical layer. Thus, even if a porous ceramic that is readily damaged is used as the ceramic with a low bulk density for the cylindrical layer, damage to or cracks in the porous ceramic can be prevented. Thus, the ceramic roller has a long service life.

The surface coating layer may be made of a fluororesin. Preferably, the fluororesin is a tube of PFA resin.

Accordingly, the surface coating layer can be relatively easily formed by introducing a ceramic for forming the cylindrical layer into a tube when the roller is produced, and heating the ceramic. Thus, the ceramic roller can be efficiently produced.

The surface coating layer may be coated with a glass layer.

Accordingly, the surface coating layer has a high heat resistance and a superior surface smoothness.

Preferably, the ceramic roller is used in a fixing device. More preferably, the ceramic roller is used in a non-pressing part of the fixing device.

Thus, the ceramic roller having the advantages inherent in the ceramic with a low bulk density can be provided.

### DESCRIPTION OF THE PREFERRED EMBODIMENTS

First Embodiment

Hereinafter, an embodiment of a heat-insulating roller according to a first aspect of the present invention will be described in detail.

Generally, rollers each comprise a shaft, a cylindrical layer, and a surface coating layer which are arranged in that order from the center toward the outside. In the ceramic roller according to the present invention, at least a part of the cylindrical layer is made of a ceramic with a low bulk density.

The shaft may be a known shaft, and preferably, is made of a metal such as iron, stainless steel, aluminum, copper, brass, or the like. The above-described ceramic with a low bulk density forms a part of the cylindrical layer. The cylindrical layer is one of the features of the present invention. The other part of the cylindrical layer, which excludes the ceramic with a low bulk density, is made, e.g., of a ceramic of which the bulk density is not low, a ceramic having a low content of pores, or a metal such as iron stainless steel, aluminum, copper, brass, or the like. This part of the layer is not restricted to any particular material. Preferably, the whole of the cylindrical member layer is made of a ceramic with a low bulk density.

The ceramic with a low bulk density forming the cylindrical layer contains, as major components, an inorganic binder and a heat-resistant inorganic material. Ordinarily, the ceramic with a low bulk density is made from 100 parts by weight of the inorganic binder and 0 to 500 parts by weight of the heat-resistant inorganic material.

The inorganic binder for forming the ceramic with a low bulk density is converted to a ceramic component, and moreover, binds to the inorganic material in the firing process of a ceramic production process, which will be described below. The inorganic material may be glass frits, colloidal silica, alumina sol, silica sol, sodium silicate, titania sol, lithium silicate, water glass, or the like. The inorganic binder is not restricted to any particular material. Also, as the inorganic binder, a combination of at least two of them may be used.

The heat-resistant inorganic material for forming the ceramic with a low bulk density is fibrous or particulate, and is not melt-deformed in the process from the kneading step to the firing step, which constitutes a part of the production process for the ceramic, which will be described below. Referring to the discrimination between the terms “fibrous” and “particulate”, a fiber is defined as one that has a sufficient length compared to the thickness and is thin and pliable, according to JIS (Japanese Industrial Standard) -L0204. However, the terms “fiber” and “particles” can not strictly be discriminated. Thus, in the description of this invention, the terms “fiber” and “particle” are used, and are not strictly discriminated. The term “heat-resistant inorganic material” includes fibers and particles. Moreover, the terms “fibrous” and “particulate” are used, if necessary.

Examples of the fibrous heat-resistant inorganic material include commonly known fibers such as alumina silica fibers, alumina fibers, chrysotile, carbon fiber, glass fibers, slag wool, silica fibers, zirconia fibers, gypsum whiskers, silicon carbide fibers, potassium titanate whiskers, aluminum borate whiskers, high silicate fibers, melted silica fibers, rock wool, and the like. A combination of at least two of them may be used.

Examples of the particulate heat-resistant inorganic material include particulate materials such as clay, calcium carbonate, talc, silica, aluminum, magnesium oxide, calcium oxide, zirconia, titania, sepiolite, kaolin, zeolite, silicon nitride, aluminum nitride, aluminoborosilicate, aluminosilicate, porous carbon, and so forth. Moreover, as a particulate heat-resistant inorganic material, hollow materials such as hollow ceramics, glass balloons, and so forth can be used. Also, a combination of at least two of them may be used.

The length of the fibrous heat-resistant inorganic material (or the longer diameter of the particular heat-resistant inorganic material) has no particular limitations. Preferably, the length is not more than 3 mm considering the dispersion-in-water property and the extrusion forming property of the material. Preferably, the diameter of the fibrous heat-resistant inorganic material and that of the particulate material are large to some degree to reduce the internal heat capacity of the ceramic roller as a final product. For example, preferably, the diameters are in the range of 1 to 15 μm. Preferably, a hollow fibrous heat-resistant inorganic material having pores inside thereof and/or a hollow particulate heat-resistant inorganic material each having pores inside thereof are used to reduce the internal heat capacity.

The heat-resistant inorganic material is not an indispensable component. However, preferably, to enhance the heat resistance and strength, the heat-resistant inorganic material is also used. The amount of heat-resistant inorganic material used is in the range of 0 to 500 parts by weight, preferably, 100 to 300 parts by weight based on 100 parts by weight of the inorganic binder. If the amount of heat-resistant inorganic material used exceeds 500 parts by weight, the strength of an obtained ceramic with a low bulk density will be insufficient.

Referring to the ceramic with a low bulk density of the cylindrical layer, ordinarily, the bulk density is in the range of 0.2 to 1.5 g/cm³, preferably, 0.2 to 1.0 g/cm³. The heat capacity is in the range of 1×10⁻⁴ to 1.5×10³KJ/(K·cm³). The thermal conductivity is in the range of 0.03 to 1.0 W/(m·K), preferably, 0.03 to 0.58 W/(m·K). The cylindrical layer may be composed of ceramic layers with different heat capacities. For example, the part near the outer peripheral surface of the cylindrical layer may be made of a ceramic layer of which the heat capacity is lower than that of the inner part of the cylindrical layer.

Hereinafter, a method of producing the ceramic with a low bulk density to form the cylindrical layer will be described. Ordinarily, the above-described ceramic with a low bulk density is produced as follows: the inorganic binder, the heat-resistant inorganic material, an organic binder, and a water-resistant organic material, if necessary, are mixed as major components, and water is added to the mixture to form an aqueous mixture in a kneading step, and thereafter, the mixture is processed in a process involving a forming step, a drying step, and a firing step, and so forth.

The organic binder is employed, if necessary, to adjust the plasticity of the raw material mixture and improve the handling property, i.e., the strength or the like required when the mixture is formed. The organic binder includes a generally known thickener. This component is burned off in the firing step.

Examples of the organic binder include methyl cellulose, carboxymethyl cellulose, hydroxymethyl cellulose hydroxyethyl cellulose, polyvinylalcohol, phenol resin, polyacrylate, polysodiumacrylate, acrylic resin, vinyl acetate resin, polyvinylalcohol resin, epoxy resin, corn starch, and the like. Moreover, a combination of at least two of them may be used.

The amount of organic binder used is in the range of 2 to 100 parts by weight, preferably, 10 to 50 parts by weight, more preferably, 15 to 25 parts by weight based on 100 parts by weight of the inorganic binder. If the amount of organic binder used is less than 2 parts by weight, the use of the organic binder can not provide sufficient plasticity during forming. If the amount of organic binder exceeds 100 parts by weight, the content of organic matter will be excessively large, and the degreasing property will be deteriorated.

The water-resistant organic material is used to improve the forming property and increase the internal porosity of the ceramic with a low bulk density to be produced. An organic material having a water resistance sufficient to maintain the shape thereof in the process from the mixing step to the drying step is used. The spaces occupied by the organic material leave pores when the organic material is burned off in the firing step.

The type of water-resistant organic material has no particular limitations. Examples of the water-resistant organic material include water-resistant synthetic resins such as polypropylene, polyethylene, polystyrene, acrylic resin, phenol resin, and the like, natural organic materials such as wood, bamboo, and the like, and so forth. The water-resistant organic material may be fibrous or particulate. The resins as mentioned above and having foams inside thereof are preferable. Moreover, a combination of at least two of them may be used.

The discrimination between the terms “fibrous” and “particulate” of the water-resistant organic material is the same as that described above with respect to the inorganic material. Ordinarily, the diameter of the fibrous organic material and that of the particulate organic material are in the range of 1 to 2000 μm, preferably, 5 to 1000 μm, more preferably, 100 to 500 μm.

The amount of water-resistant organic material used is determined, if necessary, considering the target internal porosity of a porous material to be formed. Ordinarily, the amount of water-resistant organic material used is in the range of 0 to 300 parts by weight, preferably, 0 to 150 parts by weight, more preferably, 0 to 100 parts by weight based on 100 parts by weight of the inorganic binder. If the amount of water-resistant organic material used exceeds 300 parts by weight, the strength of the ceramic with a low bulk density is substantially reduced. Thus, the object of the present invention can not be achieved. The amount of water-resistant organic material used has a limitation which is determined in relation to the amount of the inorganic materials used. Preferably, the overall amount of water-resistant organic material and inorganic materials is in the range of 0 to 500 parts by weight based on 100 parts by weight of the inorganic binder.

In the kneading step, the heat-resistant inorganic material, the inorganic binder, the organic binder, the water-resistant organic material, and other additives in predetermined amounts are mixed with water. Thus, the mixture becomes a uniform aqueous dispersion or an aqueous plastic material. The amount of water used in the kneading step is determined so that the mixture can be properly processed in the forming step which is subsequent to the kneading step. Generally, the amount of water is about 50 to 200 percent by weight of the overall weight of the above-described solid components.

For the kneading step, for example, known kneaders such as pressing-type kneaders, twin-arm kneaders, high-speed mixers, butterfly-type mixers, and so forth can be used.

In the forming step, the cylindrical member layer of the roller is formed with the mixture. In particular, the mixture is formed by means of a mold. The mold has such a structure that the mixture can be formed so as to have a hollow portion. Alternatively, the mixture is formed after a shaft is disposed corresponding to the hollow portion. For the forming, extrusion, pressing, wet-forming or the like is employed. Thus, a cylindrical formed body or a cylindrical formed body integrated with the shaft is produced.

In the drying step which precedes the firing step, the formed body is dried at room temperature or a heating temperature so that the water component is removed, and the formed body is hardened, thus fixing the shape of the body. Ordinarily, the heating temperature is 200° C. or lower. Preferably, the drying is carried out at about 105° C., at which the water contained in the formed body can be evaporated off mildly and readily. The drying time depends on the shape of the formed body and the heating temperature. Ordinarily, the drying time is in the range of 0.5 to 12 hours.

Preferably, the firing step is divided into two sub-steps, i.e., a preparatory firing sub-step and a final firing sub-step. Ordinarily, the preparatory firing sub-step is carried out in an atmosphere such that cracks are prevented from occurring due to the rapid dissipation of the particulate organic material in the final firing sub-step, which is carried out at a high temperature after the preparatory firing sub-step. Ordinarily, the preparatory firing sub-step is carried out at 150 to 400° C. The preparatory firing time depends on the shape of the formed body and the heating temperature. Ordinarily, the preparatory firing time is in the range of about 12 to 72 hours.

Ordinarily, the final firing sub-step is carried out at a high temperature, i.e., at a temperature of 400 to 1000° C. In this sub-step, the remaining particular organic material and organic binder are completely dissipated, and the inorganic binder is melted so that the whole of the formed piece is integrated. The heating time of the final firing sub-step depends of the shape of the formed piece, the heating temperature, the component materials used, the compounding ratios, and so forth, and ordinarily, is in the range of about 0.5 to 24 hours.

As described above, in the firing step, the water-resistant organic material, the organic binder, and other organic components of the formed piece of the mixture are completely burned off, and the inorganic binder is heat-melted so as to be integrated with the heat-resistant inorganic material. Thus, a fired piece substantially made of the inorganic component only, i.e., a ceramic with a low bulk density is produced. The ceramic with a low bulk density may be secondary-processed, e.g., a surface coat may be formed on the outer peripheral surface, if necessary.

Referring to the secondary processing, for example, the outer peripheral surface of the cylindrical layer is coated with a layer of fluororesin film such as PFA resin film, or the surface is coated with an inorganic layer such as a glass layer.

Referring to a method of coating the surface with the fluororesin layer as described above, the following may be employed: an adhesive is applied onto the surface of the cylindrical piece, if necessary, and then, a heat-shrinkable cylindrical film is wrapped around a roller-shaped piece and heated so that the film is heat-shrunk to closely contact the surface; a tube is heated in order to be fused; a solution of a fluororesin capable of forming a film is applied, and heated to be dried to form a film, e.g., by the doctor-coating method or the like.

As the heat-shrinkable fluororesin, preferably, PFA (perfluoroalkyl-vinyether copolymerization resin), PTFE (polytetrafluoroethylene resin), FEP (tetrafluoroethylene-hexafluoropropylene copolymerization resin) or the like is used. PFA is most suitable from the standpoint of the heat resistance and the processability.

In the case in which a tube is wrapped to form the fluororesin layer, ordinarily, the thickness of the tube after the heat-shrinking is in the range of 5 to 500 μm, preferably, 20 to 100 μm. If the thickness is less than 5 μm, creases may occur due to the distortion of the fixing roller. If the thickness of the tube exceeds 500 μm, the cost is increased and thus, the tube is economically unfavorable. In the case in which the coating is carried out by the coating method, preferably, the thickness is not more than 100 μm. Suitably, for practical use, the thickness is in the range of about 30 to 50 μm from the standpoint of the service life and processing accuracy.

Referring to a method of coating the fluororesin solution and then heat-drying to form a film, any known methods can be applied. For example, for the coating, brushing, dip-coating, spray-coating, roller-coating, bar-coating, spin-coating, and so forth may be used. In the case of rollers having a partially different shape or a small size, manual coating is effective.

As the method of coating the surface with a glass layer, spray coating, electrostatic powder coating, doctor-coating, and the like may be applied.

The ceramic roller of the present invention produced as described above has a small bulk density, and hence, the heat capacity and the thermal conductivity are small. Therefore, the ceramic roller is suitable for such uses that require a high thermal insulating property. On the other hand, the ceramic roller of the present invention has a low resistance to pressure. Thus, the ceramic roller of the present invention, if it is used in a fixing device, is suitable as a roller to which substantially no pressure is applied, not as a fixing or pressing roller to which a large pressure is applied. The above-described non-pressing rollers are different, including, e.g., conveying rollers, assisting rollers, drive rollers, release rollers, tension rollers, driving rollers, guide rollers, or the like.

Second Embodiment

Hereinafter, an embodiment of the ceramic roller of the present invention will be described with reference to the drawings in detail.

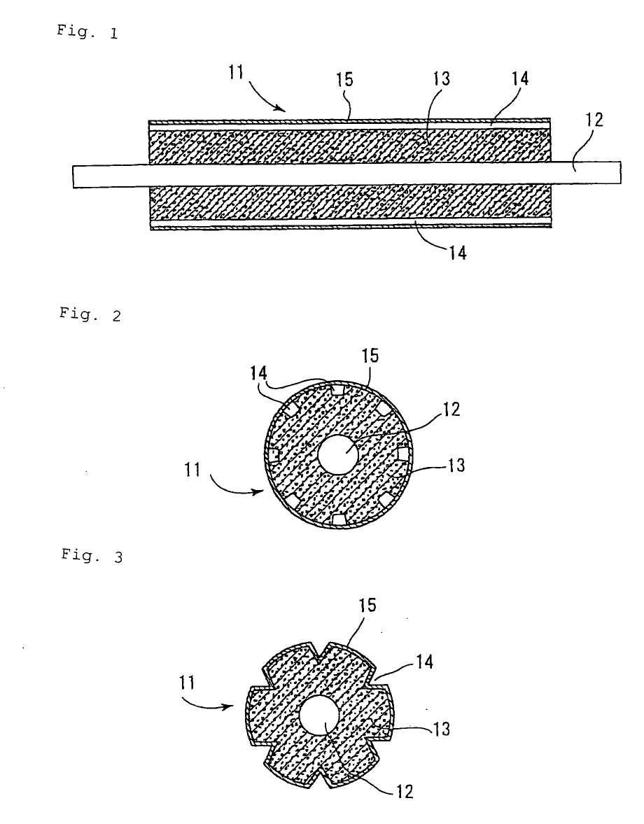

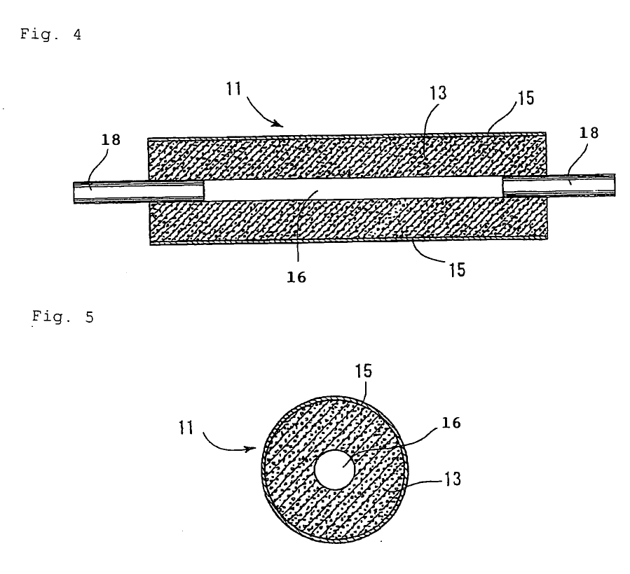

FIG. 1 is a transverse cross-sectional view of an example of the ceramic roller according to a second aspect of the present invention. FIG. 2 is a longitudinal cross-sectional view thereof. FIG. 3 is a longitudinal cross-sectional view of another example of the ceramic roller according to the second aspect of the present invention.

Referring to FIGS. 1 and 2, advantageously, the ceramic roller 11 according to the second aspect of the present invention is used as a guide roller for guiding an endless belt in a fixing device of a belt nip system which constitutes an image forming apparatus. Regarding the structure of the ceramic roller 11, the roller 11 contains a metallic shaft 12. A cylindrical layer 13 is formed on the part of the shaft 12 excluding both end portions of the shaft 12 which correspond to bearing portions. The cylindrical layer 13 has a predetermined thickness, and is integrated with the shaft 12. Plural concave grooves 14 are formed on the surface of the cylindrical layer 13. The concave grooves 14 form convexities and concavities which reduce the contact area with the nip belt. Moreover, a surface coating layer 15 is formed on the surface of the cylindrical layer 13 to protect the cylindrical layer 13 from being damaged.

The shaft 12 may be made of a metal such as iron, stainless steel, brass, or the like, which is usually used. The thickness of the shaft 12 is set at a size at which its function as a shaft can be performed. Moreover, for example, the surface of the shaft may be surface-roughened to provide enhanced bonding strength for the cylindrical layer 13.

The cylindrical layer 13 is made of a porous ceramic. Usually, the porous ceramic can be formed by firing a mixture which contains, as major components, 100 parts by weight of an inorganic binder and 0 to 500 parts by weight of a heat-resistant inorganic material, and is capable of forming pores with an internal porosity of 40 to 90%.

The inorganic binder is converted to a ceramic component and binds to the inorganic materials in the firing step for the cylindrical layer 13. The inorganic binder is not restricted to any particular material. For example, the inorganic binder may be glass frits, colloidal silica, alumina sol, silica sol, sodium silicate, titania sol, lithium silicate, water glass, or the like. Moreover, a combination of at least two of them may be used.

The heat-resistant inorganic material is fibrous or particulate, and is not substantially melt-deformed in a process from the kneading step to the firing step, which constitute a part of the forming process for the cylindrical layer 13. Referring to the discrimination between the terms “fibrous” and “particulate”, a fiber is defined as one that has a sufficient length compared to the thickness and is thin and pliable, according to JIS-L0204. However, “fibers” and “particles” can not strictly be discriminated. Thus, also in the description of this invention, the terms “fibers” and “particles” are not strictly discriminated. The term “heat-resistant inorganic material” includes both fibers and particles. The terms “fibrous” and “particulate” are used, if necessary.

Examples of the fibrous heat-resistant inorganic material include commonly known fibers such as alumina silica fibers, alumina fibers, chrysotile, glass fibers, slag wool, silica fibers, zirconia fibers, gypsum whiskers, silicon carbide fibers, potassium titanate whiskers, aluminum borate whiskers, high silicate fibers, melted silica fibers, rock wool, and the like. In addition, a combination of at least two of them may be used.

Examples of the particulate heat-resistant inorganic material include particulate materials such as clay, calcium carbonate, talc, silica, aluminum, magnesium oxide, calcium oxide, zirconia, titania, sepiolite, kaolin, zeolite, silicon nitride, aluminum nitride, aluminoborosilicate, aluminosilicate, and so forth. Moreover, a combination of at least two of them may be used.

The heat-resistant inorganic material is not an indispensable component. However, preferably, to enhance the heat resistance and strength, the heat-resistant inorganic material is also used. The amount of heat-resistant inorganic material used is in the range of 0 to 500 parts by weight, preferably, 100 to 300 parts by weight based on 100 parts by weight of the inorganic binder. If the amount of heat-resistant inorganic material used exceeds 500 parts by weight, the strength of an obtained ceramic with a low bulk density will be insufficient.

Referring to the ceramic with a low bulk density for the cylindrical layer 13, ordinarily, the bulk density is in the range of 0.2 to 1.5 g/cm³, preferably, 0.2 to 1.0 g/cm³. The heat capacity is in the range of 1×10⁻⁴ to 1.5×10⁻³ KJ/(K·cm³).

The cylindrical layer 13 of porous ceramic is formed on the periphery of the shaft 12 with the above-described mixture. For this purpose, first, a formed body is formed on the shaft 12 with the mixture so as to have a uniform thickness, extend in parallel to the axis of the shaft, and have concave grooves 14 at substantially equal intervals in the circumferential direction by means of an extrusion-forming machine or a press-forming machine.

In this embodiment, the concave grooves 14 are formed when the formed body is formed with the mixture, so that the contact area between the surface (peripheral surface) of the ceramic roller and a belt guided in contact with the roller is reduced. Thus, it is desirable to increase the ratio of the area of the concave grooves 14 to the surface area of the ceramic roller. However, if the area of the concave grooves 14 is excessively large, the strength of the cylindrical layer 13 in the convexities defined between the grooves 14 will be reduced, and guide-slippage will readily occur. The shape and the number of grooves or concavities-convexities are determined considering the above-described defects. In this embodiment, the concave grooves 14 are formed so as to be in parallel to the axial direction of the roller. However, this is not restrictive. For example, a plurality of grooves extending in the circumferential direction may be arranged in the axial direction, or in numerous concaves and convexities in a knurl-shape may be formed on the peripheral surface.

Subsequently, the formed body is fired in the firing step. Preferably, the firing step is divided into two sub-steps, i.e., a preparatory firing sub-step and a final firing sub-step. Ordinarily, the preparatory firing sub-step is carried out in an atmosphere such that cracks are prevented from occurring due to the quick dissipation of the particulate organic material in the final firing sub-step, which is subsequent to the preparatory firing step. Ordinarily, the preparatory firing step is carried out at 150 to 400° C. The preparatory firing time depends on the shape of the formed body and the heating temperature. Usually, the preparatory firing time is in the range of about 12 to 72 hours.

Ordinarily, the final firing step is carried out at a high temperature, i.e., at a temperature of 400 to 1000° C. In this step, the remaining particulate organic material and organic binder are completely dissipated, and the inorganic binder is melted so that the whole of the body is integrated. The heating time in the final firing step depends on the shape of the formed piece, the heating temperature, the components materials used, the compounding ratios, and so forth, and ordinarily, is in the range of about 0.5 to 24 hours.

As described above, the water-resistant organic material, the organic binder, and other organic components of the formed piece made of the mixture are completely burned off, and the inorganic binder is heat-melted in order to be integrated with the heat-resistant inorganic material in the firing step. Thus, the fired piece substantially made of the inorganic component only, having a thermal insulating property, and provided with concave grooves 14 formed on the peripheral surface is produced. That is, the porous ceramic layer is formed so as to be integrated with the shaft 12.

The porous ceramic layer is formed so that the thermal insulating property of the ceramic roller 11 is enhanced. Thus, to enhance the thermal insulating property, the porosity may be increased so as not to deteriorate the strength of the porous ceramic. Also, a plurality of porous ceramic layers may be formed using a mixture of porous ceramics capable of providing different porosities, and thus, regarding the porous ceramic layers, a porous ceramic layer having a low porosity reinforces the cylindrical layer 13.

A surface coating layer 15 is formed on the surface (peripheral surface) of the formed porous ceramic layer to protect the porous ceramic layer from impacts. Referring to a means for forming the surface protecting layer 15, a fluoro-type heat-shrinkable tube, which is formed in advance, may be wrapped around the surface of the porous ceramic layer, as shown in FIG. 2. Moreover, as shown in FIG. 3, a fused material containing an inorganic powder such as glass or the like may be coated onto the surface of the porous ceramic layer, e.g., by dip-coating, spraying, or the like.

As the heat-shrinkable fluororesin, preferably, PFA (perfluoroalkyl-vinyether copolymerization resin), PTFE (polytetrafluoroethylene resin), FEP (tetrafluoroethylene-hexafluoropropylene copolymerization resin) or the like is used. PFA is most suitable from the standpoint of the heat resistance and the processability.

Ordinarily, the thickness of the fluoro-type heat shrinkable tube is in the range of 30 to 500 μm, preferably, 50 to 150 μm, considering the workability of the wrapping, the strength of the tube, and the like. In the case of the surface coating layer formed by the above-described coating, it is advantageous that the thickness of the layer be in the range of 10 to 100 μm, preferably, 30 to 80 μm.

In the case in which the fluoro-type heat-shrinkable film is wrapped around the surface of the porous ceramic layer, the heat-shrinkable tube is made to closely contact the surface of the porous ceramic layer by use of the shrinking force of the heat-shrinkable fluoro-tube. If the contacting force is insufficient, an adhesive may be applied, if necessary.

As described above, in the above-described ceramic roller, the concave grooves, or convexities and concavities are formed on the surface of the cylindrical layer, so that the contact area thereof with a guided piece is reduced. Thus, the ceramic roller has a low thermal conductivity or a high thermal insulating effect.

As described above, the surface coating layer is provided on the surface of the cylindrical layer. Thus, damage to the cylindrical layer can be prevented, and the service-life of the ceramic roller can be enhanced.

Third Embodiment

Hereinafter, an embodiment of a ceramic roller according to a third aspect of the present invention will be described with reference to the drawings in detail.

FIG. 4 is a transverse cross-sectional view of a ceramic roller according to the third aspect of the present invention. FIG. 5 is a central cross-sectional view thereof.

Referring to FIGS. 4 and 5, advantageously, the ceramic roller 11 according to the third aspect of the present invention is used as a guide roller for guiding an endless belt in a fixing device of a belt nip system which constitutes an image-forming apparatus. The ceramic roller 11 comprises a cylindrical layer 13 containing a shaft hole 16 extending in parallel to the axial line of the roller 11, shaft members 18 each having one end portion thereof fixed in the opening portion in one end of the shaft hole 16, and the other end portion of the shaft member 18 projecting from the one end of the cylindrical layer 13, the shaft member 18 being made of a metal and integrated with the cylindrical layer 13, and a surface-coating layer 15 formed on the surface of the cylindrical layer 13 so that the cylindrical layer 13 is prevented from being damaged.

Thus, a hollow portion is provided inside the ceramic roller 11 having the above-described structure, i.e., inside the shaft hole 16 formed in the cylindrical layer 13. Both ends of the hollow portion are closed with the inside ends of the shaft members 18.

The metallic shaft members 18 may be made of a metal such as iron, stainless steel, brass, or a heat-resistant resin such as PPS, a fluororesin or the like, which is usually used. The thickness of the shaft members 18 is set at such a size that the members 18 can properly function as shafts. Moreover, for example, the surfaces of the shaft members 18 may be surface-roughened to provide an enhanced bonding strength for the cylindrical layer 13.

The cylindrical layer 13 is made of a porous ceramic. Ordinarily, the porous ceramic can be formed by firing a mixture which contains, as major components, 100 parts by weight of an inorganic binder and 0 to 500 parts by weight of a heat-resistant inorganic material, and is capable of forming pores with an internal porosity of 40 to 90%.

The inorganic binder is converted to a ceramic component and binds to the inorganic materials in the firing step for the cylindrical layer 13. The inorganic binder is not restricted to any particular material, for example, the inorganic binder may be glass frits, colloidal silica, alumina sol, silica sol, sodium silicate, titania sol, lithium siliate, water glass, or the like. Moreover, a combination of at least two of them may be used.

The heat-resistant inorganic material is fibrous or particulate, and is not melt-deformed in a process from the kneading step to the firing step, which constitutes a part of the forming process for the cylindrical layer 13. Referring to the discrimination between the terms “fibrous” and “particulate”, a fiber is defined as one which has a sufficient length compared to the thickness and is thin and pliable according to JIS-L0204. However, “fibers” and “particles” can not strictly be discriminated. Thus, also in the description of this invention, the terms “fibers” and “particles” are not strictly discriminated. The “heat-resistant inorganic material” includes both fibers and particles. Thus, the terms “fibrous” and “particulate” are used, if necessary.

Examples of the fibrous heat-resistant inorganic material include commonly known fibers such as alumina silica fibers, alumina fibers, chrysotile, glass fibers, slag wool, silica fibers, zirconia fibers, gypsum whiskers, silicon carbide fibers, potassium titanate whiskers, aluminum borate whiskers, high silicate fibers, melted silica fibers, rock wool, and the like. Moreover, a combination of at least two of them may be used.

Examples of the particulate heat-resistant inorganic material include particulate materials such as clay, calcium carbonate, talc, silica, aluminum, magnesium oxide, calcium oxide, zirconia, titania, sepiolite, kaolin, zeolite, silicon nitride, aluminum nitride, aluminoborosilicate, aluminosilicate, and so forth. Moreover, a combination of at least two of them may be used.

The heat-resistant inorganic material is not an indispensable component. However, preferably, to enhance the heat resistance and strength, the heat-resistant inorganic material is also used. The amount of heat-resistant inorganic material used is in the range of 0 to 500 parts by weight, preferably, 100 to 300 parts by weight based on 100 parts by weight of the inorganic binder. If the amount of heat-resistant inorganic material used exceeds 500 parts by weight, the strength of an obtained ceramic with a low bulk density will be insufficient.

Referring to the ceramic with a low bulk density for use in the cylindrical layer 13, ordinarily, the bulk density is in the range of 0.2 to 1.5 g/cm³, preferably, 0.2 to 1.0 g/cm³. The heat capacity is in the range of 1×10⁻⁴ to 1.5×10⁻³ KJ/(K·cm³).

The cylindrical layer 13 of porous ceramic is formed using the mixture. In particular, a formed body is formed by means of an extruder or a pressing machine in such a manner that the body has a uniform thickness on the periphery of the shaft hole 16 having a predetermined hole-size.

Subsequently, the formed body of the mixture is fired in the firing step. Preferably, the firing step is divided into two sub-steps, i.e., a preparatory firing sub-step and a final firing sub-step. Ordinarily, the preparatory firing sub-step is carried out in an atmosphere such that cracks are prevented from occurring due to the rapid dissipation of the particulate organic material in the subsequent final firing sub-step. Usually, the preparatory firing sub-step is carried out at 150 to 400° C. The preparatory firing time depends on the shape of the formed body and the heating temperature, and ordinarily, is in the range of about 12 to 72 hours.

Usually, the final firing sub-step is carried out at a high temperature, i.e., at a temperature of 400 to 1000° C. In this sub-step, the remaining particulate organic material and organic binder are completely dissipated, and the inorganic binder is melted so that the whole of the fired piece is integrated. The heating time of the final firing sub-step depends on the shape of the formed piece, the heating temperature, the components of the materials used, the compounding ratios, and so forth. Ordinarily, the final firing time is in the range of about 0.5 to 24 hours.

As described above, the water-resistant organic material, the organic binder, and other organic components of the formed body made of the mixture are completely burned off, and the inorganic binder is heat-melted in order to be integrated with the heat-resistant inorganic material in the firing step. Thus, the fired piece substantially made of the inorganic component only, having a thermal insulating property, is produced. That is, the cylindrical layer 13 of porous ceramic is formed by firing.

As seen in the above-description, the cylindrical layer 13 is formed so that the thermal insulating property of the ceramic roller 11 is enhanced. Thus, to enhance the thermal insulating property, the porosity may be increased, provided that the strength of the porous ceramic is not deteriorated. Also, a plurality of porous ceramic layers may be formed using mixtures of porous ceramics capable of providing different porosities. Thus, regarding the porous ceramic layers, a porous ceramic layer having a low porosity reinforces the cylindrical layer 13.

The surface coating layer 15 is formed on the surface (peripheral surface) of the formed porous ceramic layer to protect the porous ceramic layer from impacts. Referring to a means for forming the surface coating layer 15, a fluoro-type heat-shrinkable tube, which is formed in advance, is wrapped around the surface of the porous ceramic layer. A fused material containing an inorganic powder such as glass or the like may be coated onto the surface of the porous ceramic layer, e.g., by dip-coating, spraying, or the like.

As the heat-shrinkable fluororesin, preferably, preferably, PFA (perfluoroalkyl-vinylether copolymerization resin), PTFE (polytetrafluoroethylene resin), FEP (tetrafluoroethylene-hexafluoropropylene copolymerization resin) or the like is used. PFA is most suitable from the standpoint of the heat resistance and the processability.

Ordinarily, the thickness of the fluoro-type heat shrinkable tube is in the range of 10 to 500 μm, preferably, 50 to 150 μm, considering the workability of the wrapping, the strength of the tube, and the like. In the case of the surface coating layer formed by the above-described coating, it is advantageous that the thickness of the layer be in the range of 10 to 100 μm, preferably, 30 to 80 μm.

In the case in which the above-described fluoro-type heat-shrinkable film is wrapped around the surface of the porous ceramic layer, the heat-shrinkable tube is made to closely contact the surface of the porous ceramic layer by use of the shrinking force of the heat-shrinkable fluoro-tube. If the contacting force is insufficient, an adhesive may be applied, if necessary.

The shaft members 18 are fixed in both of the ends of the shaft hole 16 of the cylindrical layer 13 simultaneously with or after the formation of the cylindrical layer 13. In the case in which the shaft members 18 are fixed after the formation of the cylindrical layer 13, the cylindrical layer 13 and the shaft members 18 are fixed in order to be integrated with each other by fixing with a known adhesive or by mechanical fixing such as fitting or the like.

Preferably, the length of the shaft member over which the shaft member 14 is inserted into the shaft hole 12 is set as short as possible, provided that the bonding strength between the shaft members 18 and the cylindrical layer 13 is not insufficient. The reason for this is as follows: for the reduction of the heat capacity of the ceramic roller 11 and the decrease of the thermal conduction to the shaft members 18, it is desirable to securely form a large hollow region of the shaft hole 18 and reduce the contact area between the shaft members 18 and the cylindrical layer 13.

As described above, the main part of the ceramic roller 11 comprises the cylindrical layer 13, and moreover, the inside of the cylindrical layer 13 has a hollow structure. Thus, the heat capacity of the ceramic roller 11 is significantly reduced. Accordingly, when the ceramic roller 11 is used, e.g., as a belt guide roller in the belt nip system heat-fixing device of an image-forming apparatus, the ceramic roller 11 can greatly contribute to heat energy-saving.

Moreover, the surface coating layer 15 is formed on the surface of the cylindrical layer 13. Thus, damage to the cylindrical layer 13 can be prevented, and the service life of the ceramic roller 11 can be enhanced.

### EXAMPLES

Hereinafter, the present invention will be described with reference to Examples. The present invention is not restricted to these Examples. In Examples and Comparative Examples, the evaluation with respect to the items described in Table 1 was carried out according to the following testing method;

(1) Bulk Density (g/cm³): the bulk density is determined based on the weight of a test piece and the volume thereof calculated from the shape and size. (2) Internal Heat Capacity (J/cm³): a test piece is crushed, the specific heat is measured using 50 g of the crushed material by means of a high temperature falling-type specific heat meter, and the internal heat capacity is calculated using the bulk density. (3) Thermal Conductivity (W/(m·K)); the thermal conductivity at room temperature is measured by means of a quick thermal conductivity meter GTM-500 manufactured by Kyoto Electronics Manufacturing Co., Ltd.

### Example 1

Preparation of Plastic Mixture:

Regarding the compounding and composition of a mixture, 100 parts by weight of ceramic fibers, 100 parts by weight of glass frits as an inorganic binder, 60 parts by weight of polyethylene fibers as a combustible organic material, and 20 parts by weight of methyl cellulose as an organic binder were mixed with 125 parts by weight of water. Thus, an aqueous mixture was produced. The mixture was kneaded with a twin-arm type kneader to form a plastic mixture.

Formation of Roller;

A mold was used which comprised an outer-mold having a shape corresponding to a rod with an outside diameter of 20 cm and a length of 330 mm, and holes formed in the centers on both of the end-faces of the outer mold, the holes being such that a shaft with an outside diameter of 8 mm could be supported therein. A shaft with an outside diameter of 8 mm was set in the mold, and the mold was filled with the plastic mixture. Thus, a roller formed body comprising the shaft and the cylindrical layer was obtained. The formed-body was dried at 105° C. for 5 hours in order to harden, and then, was heated at a temperature ranging from 300 to 400° C. for an overall heating time of 24 hours. Thus, the contained polyethylene fibers and methyl cellulose were burned off. Thereafter, the body was fired at 600° C. for 3 hours in the atmosphere, so that the inorganic binder was melted, and the inorganic components were integrated with each other in the cylindrical layer. Thus, two ceramic pieces with a low bulk density were formed.

Moreover, a prism with a width of 100 mm, a length of 50 mm, and a thickness of 20 mm was formed. Thus, a ceramic piece with a low bulk density for use in determination of the thermal conductivity was obtained.

Regarding one of the produced ceramic pieces with a low bulk density, the bulk density and the internal heat capacity were measured. Moreover, regarding the formed prism-shaped ceramic with a low bulk density, the thermal conductivity was measured in the above-described way. Table 1 shows the results.

A tubular heat-shrinkable PFA (perfluoroalkyl-vinylether copolymerization resin) was wrapped around the outer peripheral surface of the other ceramic-piece with a low bulk density. The inside diameter of the tube when it was extended into a cylindrical shape was 20.1 mm, and the thickness was 30 μm. The tubular film was heat-shrunk with blown hot air having a temperature of 200° C. Thus, the ceramic roller of which the surface was coated with the PFA tube was produced.

### Example 2

Preparation of Plastic Mixture for Use on the Shaft-Side:

Regarding the compounding and composition of a mixture, 100 parts by weight of glass fibers, 100 parts by weight of glass frits as an inorganic binder, and 20 parts by weight of methyl cellulose as an organic binder were mixed with 100 parts by weight of water. Thus, an aqueous mixture was produced. The mixture was kneaded with a twin-arm type kneader to form a plastic mixture.

Preparation of Plastic Mixture for Use on the Outer Peripheral Surface Side:

Regarding the compounding and composition of a mixture, 100 parts by weight of ceramic fibers, 100 parts by weight of glass frits as an inorganic binder, 100 parts by weight of polyethylene fibers as a combustible organic material, and 20 parts by weight of methyl cellulose as a combustible thickener were mixed with 200 parts by weight of water. Thus, an aqueous mixture was produced. The mixture was kneaded with a twin-arm type kneader to form a plastic mixture.

Formation of Roller:

A mold comprising an outer-mold having a shape corresponding to a rod with an outside diameter of 16 cm and a length of 330 mm, and holes formed in the centers on both of the end-faces of the outer mold was used. The holes were such that a shaft with an outside diameter of 8 mm could be supported therein. A shaft with an outside diameter of 8 mm was set in the mold, and the outer mold was filled with the plastic mixture for use on the shaft side. Thus, one roller formed body with an outer diameter of 16 mm comprising the shaft and the cylindrical layer was obtained. Another ceramic-body with a low bulk density having an outer diameter of 20 mm, for use in measurement of the properties of the ceramic, was formed using the same plastic mixture as described above. The obtained formed bodies were dried at 105° C. for 5 hours in order to harden.

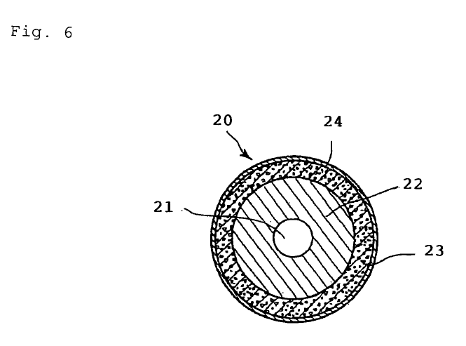

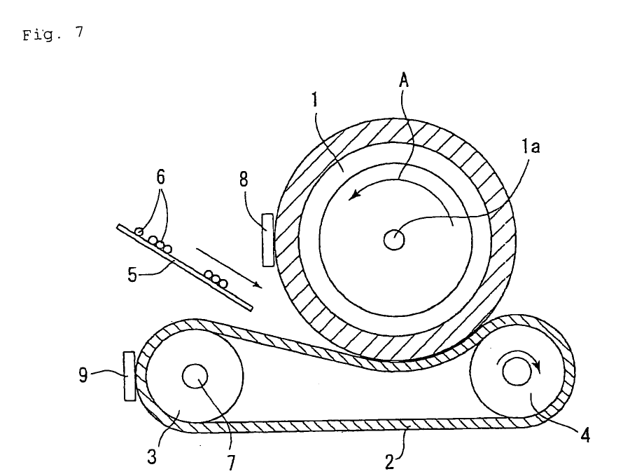

Subsequently, a mold comprising an outer-mold having a shape corresponding to a rod with an outside diameter of 20 cm and a length of 330 mm, and holes formed in the centers on both of the end-faces of the outer mold was used. The holes were such that a shaft with an outside diameter of 8 mm could be supported therein. The above-described roller formed body with an outside diameter of 16 mm was set in the mold, and the outer mold was filled with the plastic mixture for use on the outer peripheral surface side. Thus, one roller formed body with an outer diameter of 20 mm comprising the shaft and the cylindrical layer was obtained. Another ceramic-body with a low bulk density having an outer diameter of 20 mm, for use in measurement of the properties of the ceramic, was formed using the same plastic mixture as described above. The obtained formed-bodies were dried at 105° C. for 5 hours and hardened. The obtained dried pieces were fired in the same manner as described in Example 1. Thus, the inorganic binder was melted, and the inorganic components were integrated with each other in the cylindrical layer. Thus, one ceramic piece with a low bulk density and one roller for use in measurement of the properties of the ceramic were obtained. FIG. 6 is a cross-sectional view of the ceramic roller produced in Example 2, and shows the structure of the roller.

Similarly, prism-shaped ceramic pieces with a low bulk density for use on the shaft side and for use on the outer peripheral side were formed for measurement of the thermal conductivity.

Regarding one of the ceramic pieces with a low bulk density and the prism-shaped ceramic pieces with a low bulk density, the bulk densities, the internal heat capacities, and the thermal conductivities were measured for the parts thereof on the shaft side and the parts thereof on the outer peripheral surface side. Moreover, for the remaining one ceramic piece, a ceramic roller having the surface coated with a PFA tubular film in a similar manner as in Example 1 was obtained.

### Comparative Example 1

A shaft comprising an aluminum pipe with an inside diameter of 18 mm, an outside diameter of 20 mm, and a length of 330 mm and disk-shaped heads with an outside diameter of 18 mm disposed in the opening portions on both of the ends of the aluminum pipe was used. PFA resin was coated on the outer peripheral surface and dried to form a surface coating layer with a thickness of 50 μm. Thus, a roller was obtained. The bulk density in the thick portion thereof was 2.7 g/m³. The warm-up time (waiting time) of the roller was long, and thus, the use of the roller was not convenient. On the other hand, the durability was good.

### Comparative Example 2

One roller having the same shape and size as that in Example 1 was produced in the same manner as in Example 1, except that a silicone rubber sponge was used instead of the cylindrical layer of the ceramic with a low bulk density in Example 1. For the roller, the warm-up time (waiting time) was short. However, the time-dependent heat degradation was large compared to that of the ceramics in Examples 1 and 2, and thus, the durability was inferior.

TABLE 1

| | | | | | Comparative | Comparative |
|---|---|---|---|---|---|---|
| | Material | | Example 1 | Example 2 | Example 1 | Example 2 |
| Cylindrical | Shaft side | Ceramic fiber | 100 | 100 | Aluminum | Silicone |
| layer: | (parts by | Glass fiber | | 100 | pipe with | rubber |
| length | weight) | Glass frits | 100 | | thickness | Sponge |
| (330 mm), | | Polyethylene | 60 | | of 1 mm | |
| outside | | Methyl | 20 | 20 | | |
| diameter | | cellulose | | | | |
| (20 mm), | | Water | 125 | 100 | | |
| inside | | Bulk density | 0.7 | 1.0 | 2.7 | 0.7 |
| diameter | Outer | Ceramic fiber | — | 100 | — | — |
| (8 mm) | peripheral | Glass fiber | — | | | |
| | surface | Glass frits | — | 100 | | |
| | side | Polyethylene | — | 100 | | |
| | (parts by | Methyl | — | 20 | | |
| | weight) | cellulose | | | | |
| | | Water | — | 200 | | |
| | | Bulk density | — | 0.5 | — | — |
| | | g/cm³ | | | | |

| | | | | | |
|---|---|---|---|---|---|
| Surface | Material type | PFA Tube | PFA Tube | PFA Cord | — |
| coating | Thickness (μm) | 30 | 30 | 50 | — |
| layer | | | | | |

Evaluation results

| | | | |
|---|---|---|---|
| Heat capacity KJ/Kcm³ | On shaft side | 5.9 × 10⁻⁴ | 8.4 × 10⁻⁴ |
| | On outer | — | 4.2 × 10⁻⁴ |
| | peripheral | | |
| | side | | |
| Thermal conductivity | On shaft side | 0.13 | 0.22 |
| W/m K | On outer | — | 0.08 |
| | peripheral | | |
| | side | | |

| | | | | |
|---|---|---|---|---|
| Waiting time | Short | Short | Long | Short |
| Durability | Superior | Superior | Superior | Inferior |

1. A ceramic roller which comprises a shaft, a cylindrical layer, and a surface coating layer arranged in that order from the central side thereof, at least a part of the cylindrical layer being made of a ceramic with a low bulk density of 0.2 to 1.5 g/cm³, the ceramic being formed from 100 parts by weight of an inorganic binder and 0 to 500 parts by weight of a heat-resistant inorganic material.

2. A ceramic roller with a low heat capacity according to claim 1, characterized in that the cylindrical layer is formed of a ceramic with a low bulk density having a heat capacity per unit volume of 1×10⁻⁴ to 1.5×10⁻³ KJ/(K·cm³).

3. A ceramic roller according to claim 1, characterized in that the thermal conductivity of the cylindrical layer is in the range of 0.03 to 1.0 W/(m·K).

4. A ceramic roller according to claim 1 characterized in that grooves or convexities and concavities are formed on the peripheral surface of the cylindrical layer.

5. A ceramic roller according to claim 1, characterized in that the cylindrical layer is provided with a hollow shaft hole into which the shafts are disposed, the top-end of each shaft protruding externally from the cylindrical layer, the other end being fixed in one of both ends of the shaft hole, and the part of the shaft hole which exists between both the shafts constituting a hollow portion.

6. A ceramic roller according to claim 1, characterized in that the surface coating layer is made of a fluororesin.

7. A ceramic roller according to claim 6, characterized in that the fluororesin is a tube of PFA resin.

8. A ceramic roller according to claim 1, characterized in that the surface coating layer may be coated with a glass layer.

9. A ceramic roller according to claim 1, characterized in that the ceramic roller is used in a fixing device.

10. A ceramic roller according to claim 1 characterized in that the ceramic roller is used in a non-pressing part of the fixing device.

11. A ceramic roller which comprises a cylindrical layer with a peripheral surface formed on the peripheral surface of a shaft excluding both the ends of the shaft, the peripheral surface of the cylindrical layer having grooves or concavities and convexities formed thereon, and a surface coating layer.

12. A ceramic roller which comprises a cylindrical layer formed in a cylindrical shape having a hollow shaft-hole, a pair of shafts, one of which has the top-end thereof protruding externally from the cylindrical layer and has the other end fixed in the cylindrical layer, the shaft hole forming a hollow portion between the ends of both the shafts, and a surface layer formed on the outer peripheral surface of the cylindrical layer.
